(19) United States
(12) Patent Application Publication
(10) Pub. No.: US 2024/0210878 A1
(43) Pub. Date: Jun. 27, 2024

(54) SPARSE NANOPHOTONIC PHASED ARRAYS FOR HOLOGRAPHIC DISPLAYS

(71) Applicant: UNIVERSITY OF MARYLAND, COLLEGE PARK, College Park, MD (US)

(72) Inventors: Amitabh VARSHNEY, Potomac, MD (US); Susmija JABBIREDDY, Berwyn Heights, MD (US); Mario DAGENAIS, Chevy Chase, MD (US); Martin C. PECKERAR, Silver Spring, MD (US); Yang ZHANG, Silver Spring, MD (US)

(21) Appl. No.: 18/542,174

(22) Filed: Dec. 15, 2023

Related U.S. Application Data
(60) Provisional application No. 63/387,900, filed on Dec. 16, 2022.

(51) Int. Cl. G03H 1/26

(52) U.S. Cl. CPC G03H 1/265; G03H 2001/2655

(57) ABSTRACT

Sparse nanophotonic arrays (NPAs) and holographic displays comprise a rectangular footprint including an active pixel area, wherein the active pixel area includes a plurality of light-emitting elements arranged in a starburst shape, and wherein a total number of the plurality of light-emitting elements in the active pixel area is equal to a predetermined fraction of a total resolution of a dense nanophotonic array having the rectangular footprint.

### CROSS-REFERENCE TO RELATED APPLICATIONS

The present disclosure claims priority to and the benefit of U.S. Provisional Application No. 63/387,900, filed on Dec. 16, 2022, the entire contents of which are hereby incorporated by reference for all purposes.

### STATEMENT REGARDING FEDERALLY SPONSORED RESEARCH OR DEVELOPMENT

This invention was made with government support under CNS1823321 and U.S. Pat. No. 1,564,212 awarded by the National Science Foundation. The government has certain rights in the invention.

### BACKGROUND OF THE INVENTION

This present disclosure is directed to display technologies and, more particularly, to the use of nanophotonic phased arrays for holographic displays.

A nanophotonic phased array (NPA) is a holographic display technology. With chip-scaled sizes, high refresh rates, and integrated light sources, a large-scale NPA can enable high-resolution real-time dynamic holographic displays. However, there are several challenges for the development of such large-scales NPAs, including the high electrical power consumption required to modulate the amplitudes and/or phases of each of the pixel elements on the dense two-dimensional array.

The present disclosure overcomes these and other challenges by providing a sparse NPA. The present disclosure includes a method of designing and/or operating a sparse NPA, including the configuration of a sparse NPA and the amplitude and/or phase at each active pixel to generate a desired image at the observation plane. Using a fraction of the total pixels from a dense two-dimensional array of light-emitting elements, systems and methods in accordance with the present disclosure can generate perceptually acceptable holographic images.

### SUMMARY

The present disclosure provides systems and methods for sparse nanophotonic phased arrays for holographic displays. Accordingly, the present disclosure effects improvements in several technological fields, including but not limited holographic display, augmented and virtual reality (AR/VR), image processing, image rendering, display design, display manufacturing, and the like.

According to one aspect of the present disclosure, a holographic display is provided. The holographic display comprises a sparse nanophotonic array having a rectangular footprint including an active pixel area, wherein the active pixel area includes a plurality of light-emitting elements arranged in a starburst shape, and wherein a total number of the plurality of light-emitting elements in the active pixel area is equal to a predetermined fraction of a total resolution of a dense nanophotonic array having the rectangular footprint.

According to another aspect of the present disclosure, a sparse nanophotonic array is provided. The sparse nanophotonic array has a rectangular footprint, and comprises an active pixel area within the rectangular footprint, wherein the active pixel area includes a plurality of light-emitting elements arranged in a starburst shape, and wherein a total number of the plurality of light-emitting elements in the active pixel area is equal to a predetermined fraction of a total resolution of a dense nanophotonic array having the rectangular footprint.

According to another aspect of the present disclosure, a method of manufacturing a holographic display is provided. The method comprises applying an iterative algorithm to at least one image; selecting a plurality of active pixel locations based on the iterative algorithm; and producing a sparse nanophotonic array having a rectangular footprint including an active pixel area including the plurality of active pixel locations.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and form a part of this specification, illustrate examples of the disclosure and, together with the description, explain principles of the examples.

The present disclosure will provide details in the following description of preferred embodiments with reference to the following Figures wherein:

FIG. 1 illustrates an example of the use of a nanophotonic phased array for holographic displays.

FIG. 2 illustrates an example of an optical Fourier transform system.

FIG. 3 illustrates an example of a schematic overview of an algorithm.

FIG. 4 illustrates an example of a qualitative comparison of reconstructed images.

FIG. 5 illustrates an example of a graph showing image quality degradation.

FIG. 6 illustrates an example of a visualization of reconstruction quality for two sample images and the mean absolute error (MAE) for various sparsity levels.

FIG. 7 illustrates an example of a graph showing reconstruction image quality as a function of iterations.

FIG. 8 illustrates an example of a normalized histogram of active pixels.

FIG. 9 illustrates an example of low-pass filtered images.

FIG. 10 illustrates an example of graphs showing reconstruction image quality as a function of map standard deviation.

FIG. 11 illustrates an example of a globally-designed nanophotonic phased array for holographic displays.

FIG. 12 illustrates an example of a schematic overview of another algorithm.

FIG. 13 illustrates an example of a histogram of active pixels.

FIG. 14 illustrates an example of reconstruction image quality for various fractions of active elements.

FIG. 15 illustrates an example of a graph showing reconstruction image quality as a function of fraction of active elements.

FIG. 16 illustrates an example of reconstruction image quality for time-multiplexed image frames.

FIG. 17 illustrates an example of a graph showing reconstruction image quality as a function of number of frames time-multiplexed.

FIG. 18A and FIG. 18B respectively illustrate examples of a qualitative comparison of reconstructed images.

FIG. 19 illustrates an example of a nanophotonic phased array.

FIG. 20 illustrates an example of a method of manufacturing a holographic display.

These and other features and advantages will become apparent from the following detailed description of illustrative embodiments thereof, which is to be read in connection with the accompanying drawings.

Additional advantages of the invention will be set forth in part in the description which follows, and in part will be obvious from the description, or can be learned by practice of the invention.

### DETAILED DESCRIPTION

The present invention can be understood more readily by reference to the following detailed description of the invention and the examples included therein. Embodiments of the disclosure are described in detail below with reference to the accompanying figures. Unless otherwise indicated, like parts and method steps are referred to with like reference numerals.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the Figures. The spatially relative terms are intended to encompass different orientations of the device in use or operation in addition to the orientation depicted in the Figures. The apparatus may be otherwise oriented (rotated 90 degrees or at other orientations) and the spatially relative descriptors used herein may likewise be interpreted accordingly.

Throughout the application, use of ordinal numbers (e.g., first, second, third, etc.) is not intended to imply or create any particular ordering for any of the elements. Nor does the use of ordinal numbers limit any element to being only a single element, unless expressly disclosed.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Aspects of the present disclosure are best understood from the following detailed description when read with the accompanying Figures. It is noted that the dimensions of the various features within the accompanying Figures are not drawn to scale unless otherwise stated herein. Unless explicitly stated otherwise, each element having the same reference numeral is presumed to have the same material composition and to have a thickness within a same thickness range.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Computer-generated holography and holographic displays are of interest to computer graphics and optics communities. Comparative examples of AR/VR headsets rely on stereoscopic vision and cannot reproduce the depth cues used in natural vision. This leads to a phenomenon called vergence-accommodation conflict, where the images are focused on a plane at a fixed distance from the eye, while the actual depth of the objects varies. This phenomenon may lead to discomfort and hinder an immersive user experience with head-mounted displays. In contrast, holographic displays simulate natural human vision by creating the entire optical wavefield of the scene in front of the user. Holography provides a mechanism to record and display both the intensity and the phase of the light waves as emitted from the object through diffraction and interference of light. By recreating the optical wave-field of the scene, all the depth cues are provided to the human visual system, thereby overcoming the vergence-accommodation conflict. The user can view the object from different perspectives and observes as if the light is coming from the real object, thus creating a natural experience.

Holographic displays modulate the intensity and/or phase of light at each pixel location to create the desired wavefront. Liquid Crystal Display (LCD) or Liquid Crystal on Silicon (LCoS) based spatial light modulators (SLM) used in comparative examples for holographic display. However, a high-resolution LCoS-based SLM exhibits a low refresh rate (typically in the order of tens to hundreds of hertz). One alternative display with higher refresh rates is the Digital Micromirror Device (DMD). However, DMDs are limited to binary amplitude modulations and have low diffraction efficiency. NPAs may be used as an alternative for holographic display and other applications. These applications include light detection and ranging, optical communications, and biomedical imaging. NPAs offer high refresh rates (in the order of 100 kHz) and compact chip-sized displays with pixel sizes in the range of the wavelength of light. Pixel output is controlled without the need of any mechanical components. An optical phased-array (OPA) is a collection of antenna elements that emit light with the desired amplitude and phase shift, whose interference forms the desired intensity pattern at a far-field plane. Adjusting the amplitude and the phase shift of each element in the array creates different patterns on the observation plane.

A compact large-scale NPA may realize a high-resolution, wide field-of-view real-time dynamic holographic display. Designing such a large-scale NPA requires many power-hungry light-emitting optical elements packed densely on a two-dimensional array. As a result, the complexity and power consumption to achieve independent and accurate amplitude and phase control present a challenge for making holographic displays a practical one. A thermally-modulated NPA involves heating each element individually to a certain temperature to emit light with the desired phase shift. However, these elements are extremely power-hungry. For example, some comparative examples exhibit a thermal efficiency of about 8.5 mW per x-phase shift. Recent works in the silicon photonics industry address the issue of high power consumption by developing low-power large-scale OPAs.

Practical holographic displays would benefit from an NPA comprising a sparse distribution of light-emitting elements, addressing the challenges of high power demand and high complexity of the control circuit. A “sparse” NPA is one with a nonuniform distribution of light-emitting elements, such that at least some locations where a light-emitting element would be expected in a uniform array are not occupied by any light-emitting element. Comparative examples of phased arrays consist of uniformly spaced antennas for smooth spatial sampling across the array aperture (i.e., are “dense” arrays). Aperiodic non-uniform phased arrays have been used for beam steering, where achieving a narrow-bandwidth and wide field-of-view are important. In contrast, for holographic images, the display of perceptually high-quality noise-free images is of prime importance. Calculating the complex hologram wave-field that generates a specific intensity pattern at the image plane is a non-trivial exercise. It is a mathematically ill-posed problem. Comparative example algorithms have been used to compute the hologram wave-field based on either scalar diffraction based wave-propagation, iterative phase-algorithms or machine-learning. These methods assume uniform sampling, resulting in redundant information in signal representation. This redundancy facilitates an additional degree of freedom, where a small number of antennas can be sufficient to approximate the signal that creates the image at the observation plane.

The present disclosure addresses the problem of reducing the high power and complexity requirements to build a large-scale NPA-based 3D holographic display. The present disclosure describes a systematic method to configure an extremely sparse array of active antennas (e.g., having 40% or less of the number of antennas that would be present in a dense array having the same rectangular footprint) to reduce the total power consumption for the NPA. In one example, the method builds on a Gerchberg-Saxton (GS) iterative algorithm to account for complex holograms that produce the desired image at the far-field without compromising perceptual image quality. By redistributing a large fraction of energy over a small number of pixel elements, the present disclosure achieves high sparsity levels.

### Comparative Examples

After the invention of the laser, several applications were realized. Computer-generated holography (CGH) was disclosed and demonstrated with a quality comparable to optical holography. Algorithms have been explored to compute the complex holograms that optically form the required 2D or 3D intensity patterns at the observation plane. CGH algorithms can be broadly classified as point-based, ray-based, polygon-based, and layer-based methods. Point-based algorithms are the most popular ones. They consider the target scene as a collection of light sources that are propagated to the hologram plane and interfered with a reference beam. Directly computing the interference patterns from each point light source of a complex scene is computationally very expensive. Methods based on look-up tables and wavefront-recording planes were introduced to improve run time at the cost of reduced image quality.

Due to the amplitude-only or phase-only constraints of the light modulators like SLMs, the computed complex wave-field are converted to either amplitude-only or phase-only holograms. Compared to the amplitude-only hologram, the phase-only hologram is more widely considered due to its higher diffraction efficiency. Phase-coding techniques may be used to compute the approximate phase-only hologram. Alternatively, several iterative methods based on phase-retrieval have been proposed. Gerchberg and Saxton proposed the first of a family of iterative phase retrieval algorithms that account for a source-field phase pattern which, when combined with a known source-field amplitude pattern, forms the desired intensity pattern at the far-field. The original GS algorithm uses a Fourier transform to approximate the Fraunhofer diffraction over a long distance. Fresnel diffraction is also used in a similar way when the propagation distances are shorter. The iterative approaches offer better image quality than the direct methods but come at the expense of computational speed. Several machine-learning-based phase-only holograms have been explored to compute high-quality CGH at faster rates. Further, machine learning can supplement physics-based knowledge to reduce the model mismatch between the ideal simulations and actual physical devices. Generally in such methods, a uniform amplitude is considered across all the pixels to allow maximum interference. In contrast to these comparative methods, the present disclosure considers complex amplitudes to realize a sparse phase array by leveraging redundant information when the amplitude distribution across the pixel array is non-uniform.

Phased arrays were first demonstrated using radio-frequency waves and soon found applications in communication, imaging, RADAR, and astronomy. These applications were mainly limited to beam focusing and steering, as it is difficult and expensive to build large-scale arrays. With the development of lasers, optical phased arrays operating at short wavelengths were introduced. These short wavelengths, along with the advances in the integrated photonics industry, make it possible to build a large-scale phased array on a small-size footprint, extending the applications to 3D holographic displays, LiDAR, biomedical sciences, and free-space optical communication.

Thermally modulated NPAs leverage the thermo-optical properties of silicon-like materials. The phase of the element can be modulated by varying its temperature. As the pixel density increases, the thermal proximity effect, the phenomenon where the temperature of one pixel affects the temperature of neighboring pixels, impacts the accuracy of phase modulation and degrades the quality of the observed intensity pattern.

Aperiodic sparse phased arrays have been studied for radio-frequency waves. With NPAs, the number of elements required to be placed in a compact area further increased, increasing the power consumption by a large factor. Sparse optical phased arrays have been investigated for beam steering applications to achieve a narrow beam and wide FOV when the pixel pitch is greater than the sub-wavelength orders by suppressing the side-lobes. In such applications, normal and uniform distributions are sub-optimal; even better performance for beam steering can be obtained by using a fully random waveguide placement.

However, previous implementations of a sparse array configuration were limited to beam steering where a narrow bandwidth and high output power are desired. Moreover, methods based on genetic algorithms and particle swarm optimizations are limited to small scale arrays owing to the high computational complexity of the algorithms as the size of the search space of potential solutions increases. The present disclosure, by contrast, achieves sparse aperiodic phased arrays for holographic displays, where the desired far-field pattern is much more complex than beam-steering.

### Sparse NPAs for Holographic Displays—Amplitude and Phase Modulation

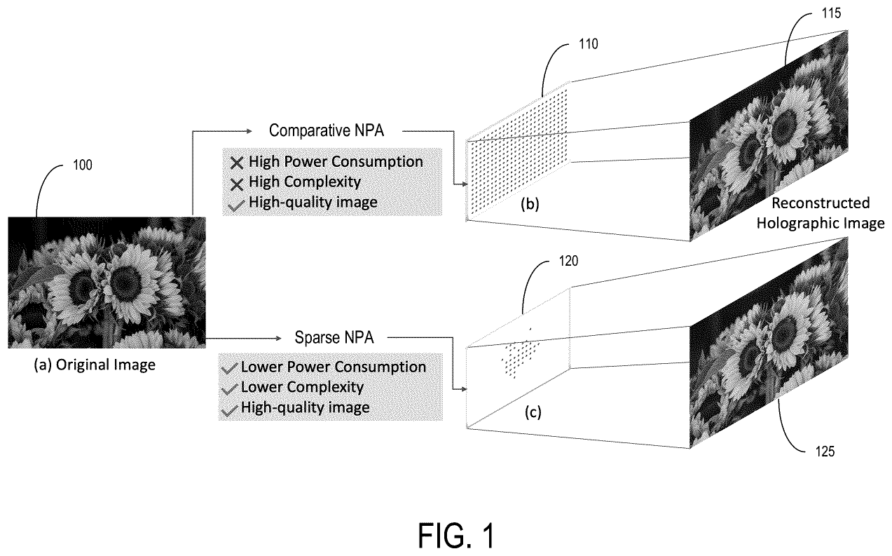

The present disclosure shows that a sparse set of antenna elements on a 2D NPA is sufficient to produce an image with a perceptual quality close to one produced by a dense array. This is conceptually illustrated in FIG. 1. In FIG. 1, an original image 100 is reproduced. On one hand, a comparative NPA 110 having a dense 3D array of light-emitting elements (also referred to herein as “pixels” or “antenna elements”) is capable of producing a reconstructed holographic image 115 that is of high-quality. However, the comparative NPA 110 is highly complex and consumes a large amount of power to modulate the amplitude and phase of the many light-emitting elements thereon. On the other hand, a sparse NPA 120 is also capable of producing a reconstructed holographic image 125 that is of high-quality with significantly reduced power consumption and complexity. The present disclosure shows that a sparse NPA 120 with only 10% of the active elements (compared to the comparative NPA 110) can achieve these effects.

Before the sparse NPA 120 is described in detail, Fourier holograms are discussed. Then, a method will be described that computes the arrangement of the pixel element son the sparse NPA 120 to form the desired image without undesirably reducing image quality.

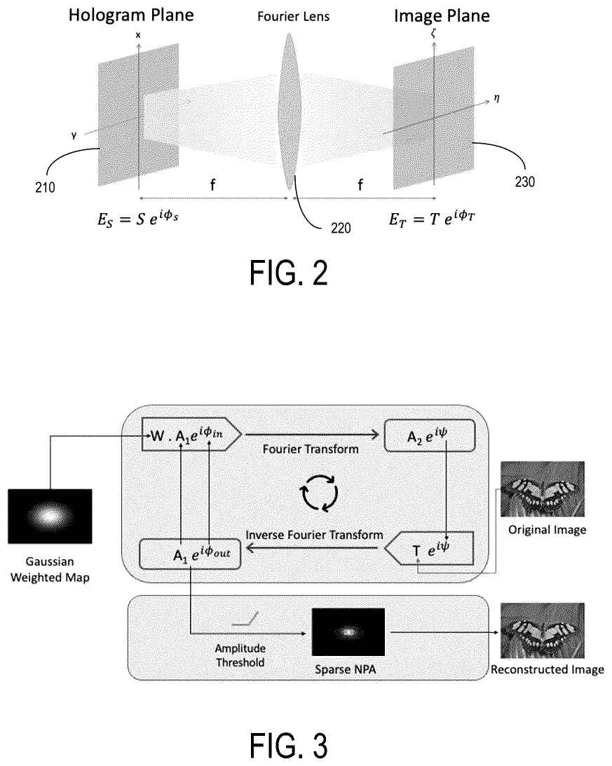

A holographic display forms images through the interference of diffracted light. The amplitude and the phase of the pixel elements on an NPA are modulated to emit a complex-valued wave-field. This modulated field propagates through free-space or optical elements to a far-field plane, where a user observes the intensity pattern formed due to the interference of the emitted light. The observed field can be approximated using the Fourier transform of the source field. An example of an optical Fourier system describing this far-field wave propagation is shown in FIG. 2. In FIG. 2, an image is projected from a hologram plane 210 (also referred to as a source plane) to an image plane 230 (also referred to as a target plane) using a Fourier lens 220. If E_{s(x,y)}=S·e^{iϕs} denotes the complex amplitude emitted from the 2D phased array, the wave field at a target plane Eₜ(ζ, η; z) placed at a distance z from the source plane (z=0), winere

$$z ≫ \frac{{π ( {x}^{2} + {y}^{2} )}_{max}}{λ}$$

is given by the following equation (1).

$${E}_{t} ( ζ , η ; z ) = \frac{{e}^{ikz}}{i λ z} {e}^{\frac{ik}{2 z} ( {ζ}^{2} + {η}^{2} )} \int \int {E}_{s} ( x , y ) {e}^{- i ( \frac{2 π}{λ z} ) ( x ζ + y η )} dxdy \qquad ( 1 )$$

By ignoring the phase factor in front of the integral, this expression is simply the Fourier transform of the source field Eₛ, evaluated at frequencies

$${f}_{ζ} = \frac{ζ}{λ z}$$

$$and$$

$${f}_{η} = \frac{η}{λ z} .$$

This expression may thus be written as the following equation (2).

$${E}_{t} ( ζ , η ; z ) = ℱ {\{ {E}_{s} ( x , y ) \}}_{{f}_{ζ} = \frac{ζ}{λ z} , {f}_{η} = \frac{η}{λ z}} \qquad ( 2 )$$

In equation (2), λ is the wavelength of light, k is the wavenumber, and F(.) denotes the Fourier transform function. The intensity of the image formed at the target plane 230 is thus given according to the following equation (3).

$${I}_{t} ( ζ , η ) ∝ {\vert ℱ \{ {E}_{s} ( x , y ) \} \vert}^{2} \qquad ( 3 )$$

In practice, the discrete amplitude and phase at the source plane are considered as S, ϕₛ E< [symbol] ^{P×Q}, where P×Q is the resolution on the phased array. Given that the far-field can be approximated from the Fourier transform of the source field, the wavefield formed at the image plane has the same resolution P×Q. For a target image/with amplitude T∈ [symbol] ^{P×Q}, one can find a sparse configuration of active pixel elements on the 2D array that forms a good approximation of the image at the far-field.

If both S and T are known measurements, one can use phase-retrieval algorithms to calculate the phase ϕₛ that minimizes the error between the produced far-field pattern and the target amplitude. In fact, with only T known, one can compute a configuration of the 2D phased array with the desired sparsity that forms the target image with nearly the same quality compared to the image formed from the dense 2D array.

In one example, an algorithm algorithm based on the GS phase-retrieval algorithm to is used compute the sparse NPA. The sparsity requirement is integrated into the phase-retrieval algorithm using a Gaussian weighted map. This algorithm is referred to herein as Gaussian-weighted GS (GGS). Sparsity is defined as the percentage of the number of pixel elements that are removed from a dense 2D array. For example, a sparsity level of 90% on a 100×100 dense 2D phased array will have 1000 active pixels distributed on the array.

This method is illustrated in FIG. 3 and in the pseudo-code presented below as Algorithm 1. As shown in FIG. 3, given an image, the GGS algorithm modifies the source amplitude and phase using an iterative approach. The Gaussian weighted map encourages sparsity in the source wavefield. Finally, the sparse NPA is configured based on the amplitude thresholding of the optimized source field.

The input to the GGS method is the target amplitude pattern T∈ [symbol] ^{P×Q} and the desired sparsity s. The algorithm finds the near-field amplitude S and phase shifts ϕₛ that together best approximate the far-field amplitude T when s % of the total pixels are removed. The algorithm is initialized with a 2D Gaussian weighted map W∈ [symbol] ^{P×Q} with standard deviations ox and oy along the horizontal and the vertical directions. The weight associated with a pixel at location (x, y) is calculated according to the following equation (4).

$$W ( x , y ) = {e}^{- \frac{1}{2} [ \frac{{( x - \frac{P}{2} )}^{2}}{{σ}_{x}^{2}} + \frac{{( y - \frac{Q}{2} )}^{2}}{{σ}_{y}^{2}} ]} \qquad ( 4 )$$

The target image plane is initialized with a random phase ψ₀ ∈ [symbol] ^{P×Q}. The function ph(.) returns the phase of a complex amplitude.

If the source amplitude S′ is known, the complex field B takes amplitude from S and the phase from A in each iteration. One comparative way to achieve sparsity is to constrain the source amplitude to zero at randomly selected non-active pixel locations. In this case, the complex field B is obtained by considering the amplitude of A corresponding to the active antenna locations and zero amplitude for inactive antennas. However, this method of constraining does not produce perceptually acceptable quality images. In the method according Algorithm 1, B is computed from the amplitude of A weighted by the Gaussian weighted map W. In each iteration, the weights from the Gaussian map redistribute the intensity in the source plane and optimize for the corresponding phase shifts. The method iterates for a maximum of a fixed number of iterations or until the convergence condition is satisfied. The convergence condition is defined on the source amplitude and is satisfied when the relative mean squared error between the previous estimate and the current estimate is less than a predefined threshold for several consecutive iterations. Once the algorithm converges, most energy gets concentrated on just a few pixel elements, forming a sparse NPA. The brighter pixels have a higher effect on the image quality. Finally, the locations of the active pixels correspond to the top (100-s)% pixels based on the modified amplitude values S and are sufficient to produce the desired target field.

```
Algorithm 1 - Gaussian weighted Gerchberg-Saxton (GGS)
Input: Amplitude T at target plane
Output: Amplitude S and phase ϕₛ at source plane
  Initialization:
  ${ψ}_{0} = rand ( ) A = {ℱ}^{- 1} ( T \cdot {e}^{i {ψ}_{s}} )$
W = Gaussian weighted map with widths σₓ and σ_{y}
while iteration < maximum iterations do
    $B = ( \vert A \vert \cdot W ) {e}^{i ph ( A )} A = {ℱ}^{- 1} \{ T \cdot {e}^{i ph ( ℱ \{ B \} )} \}$
    if convergence condition is satisfied then
      break
    end if
  end while
  $return S = \vert A \vert , {ϕ}_{s} = ph ( A )$
```

### Simulations— Amplitude and Phase Modulation

The above method was evaluated via simulation to show that a sparse configuration of an NPA displaying natural holographic images is achieved.

The method was evaluated on 32 images randomly chosen from a dataset (i.e., the DIV2K dataset) consisting of real-life images. All methods were implemented in Python. All simulations were run on a machine with an NVIDIA® GeForce® RTX 2080 GPU with 12 GB memory and an Intel® Xeon® Silver 4114 CPU at 2.20 GHz. A random phase at the image plane was considered in all methods, as it aligns more naturally to the light emitted by object sin the real world. The simulations are presented in color as the method can be applied to all wavelengths individually. Furthermore, multi-color displays can be realized by coupling three lasers into the NPA. The wavelengths for red, green, and blue channels were chosen as 630 nm, 530 nm, and 445 nm, respectively. The NPA in the simulation was chosen to have a pixel pitch of 15 μm, with the same resolution (1020×678) as that of the images considered. The image was formed at far-field of infinity.

In addition to visualizing the reconstructions, the quality of the reconstructions was quantified using two metrics: Peak Signal-to-Noise Ratio (PSNR) and Structural Similarity Index (SSIM). PSNR is a pixel-based metric that relies on the mean square error between the pixel intensities in the target and the reconstructed image. SSIM is a perceptual metric that considers texture to calculate the metric. It denotes the similarity between the two images, where the value ranges from 0 to 1, with 1 representing identical images.

The simulations show that a sparse NPA is effective in reconstructing natural images, thus validating the GGS method described above. To illustrate the effectiveness, the GGS method is compared to three baseline methods: direct thresholding (DT), binary amplitude GS (BGS), and randomized amplitude GS (RGS).

In DT, the complex hologram on the NPA is calculated directly from the inverse Fourier transform of the target complex wave-field pattern. For a given sparsity level, the percentage of the pixels corresponding to the lowest intensity values are ignored. In BGS, the locations of the active pixel elements on the NPA are configured according to a randomly uniform distribution for a given sparsity level. The phase of active pixels is obtained using the iterative GS algorithm by constraining the source amplitude to be a fixed unit intensity at active pixels and zero at inactive pixels. In RGS, similar to BGS, a randomized binary mask determines the configuration of active pixels in the array. The amplitude and the phase of the active pixels are modified using the iterative GS algorithm to minimize the error between the reconstructed image and the target image.

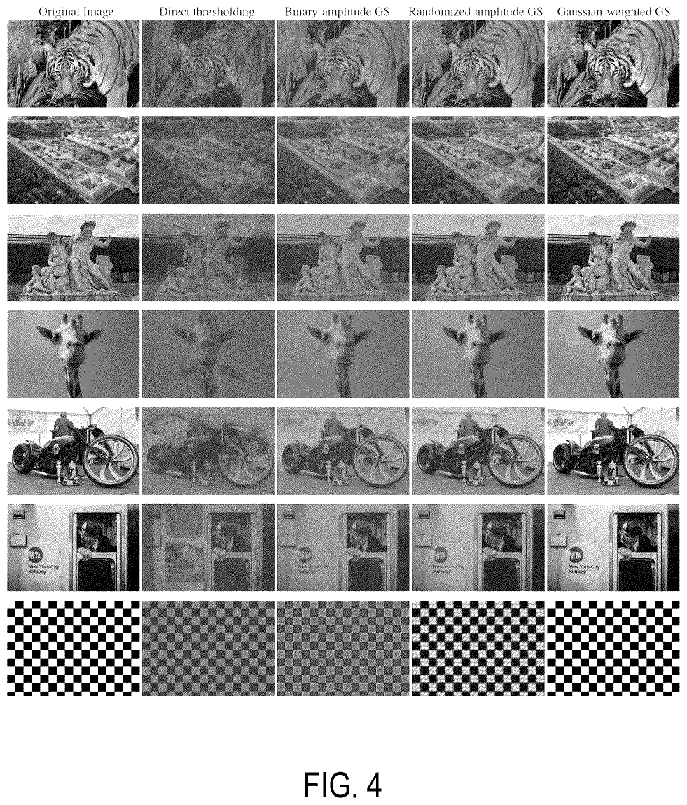

FIG. 4 illustrates simulated visual reconstructions. In FIG. 4, the left-most column shows the original images as a reference. Columns two to five represent the quality of the far-field images obtained using DT, BGS, RGS, and GGS, respectively. All the images are reconstructed using only 20% of the pixel elements in the array. It can be observed that perceptually high-quality images can be produced from an NPA by ignoring even 80% of the pixels using the Gaussian-weighted (GGS) sampling method. The same result is also demonstrated quantitatively using the image quality metrics shown in Table 1. The values indicate an average of over 32 images. By comparing various methods, we observe that Gaussian-weighted sampling performs much better than DT, BGS, and RGS, especially at higher sparsity levels.

TABLE 1

| Sparsity | Method | PSNR | SSIM |
|---|---|---|---|
| 80% | DT | 9.69 ± 1.41 | 0.10 ± 0.05 |
| | BGS | 12.58 ± 1.33 | 0.19 ± 0.07 |
| | RGS | 15.32 ± 1.36 | 0.31 ± 0.10 |
| | GGS | 32.47 ± 3.06 | 0.95 ± 0.02 |
| 90% | DT | 8.81 ± 1.28 | 0.07 ± 0.04 |
| | BGS | 10.68 ± 1.24 | 0.12 ± 0.05 |
| | RGS | 12.08 ± 1.28 | 0.17 ± 0.07 |
| | GGS | 29.17 ± 2.89 | 0.91 ± 0.04 |

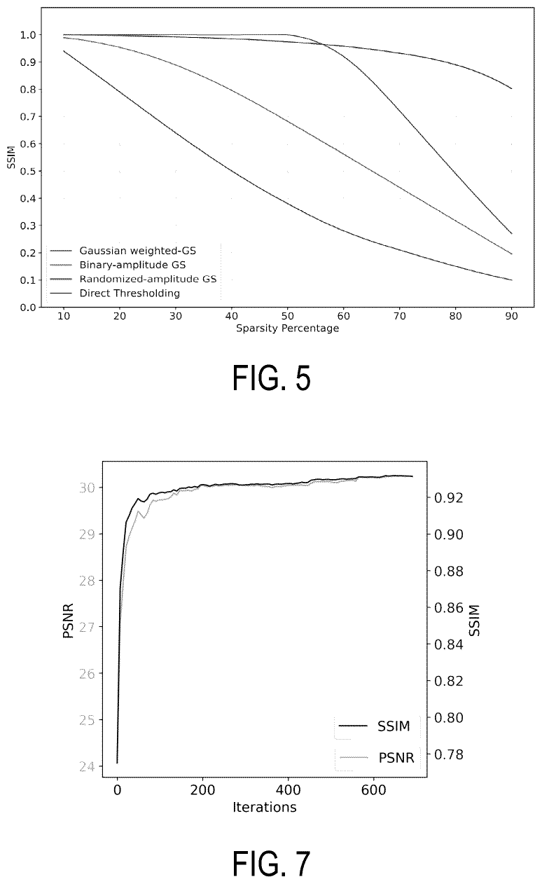

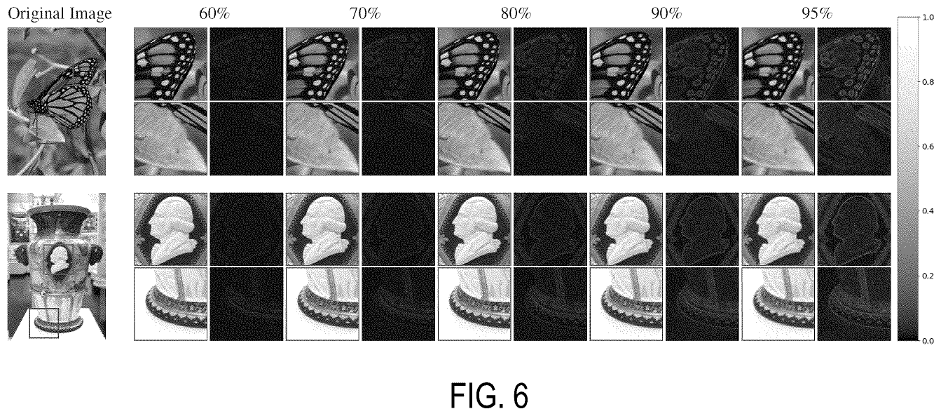

Furthermore, FIG. 5 illustrates image quality degradation for various sampling methods for an image. The figure is plotted with interpolated data with sparsity levels ranging from 10% to 90%, with an interval of 10%. The PSNR values have a high correlation with the SSIM values, and thus only SSIM values are shown in FIG. 5. As can be seen from FIG. 5, direct thresholding performs the worst even with 80% active pixels. Randomized amplitude GS optimizes for the amplitude values and the phase of the active pixels, performing well for lower sparsity levels compared to the binary amplitude GS method. However, reconstructed image quality drastically drops when more than 60% of the pixels are removed. The Gaussian weighted sampling method retains the best image quality at high sparsity levels. While not seeking to be bound by any one theory of operation, this may be due to the additional degree of freedom available in the Gaussian weighted sampling method. The method considers the locations, in addition to the amplitude and the phase values. The same result is also visualized in FIG. 6, which shows the reconstructions from the Gaussian GS method along with the mean absolute error (MAE) for two sample images for various sparsity levels.

The quality of the reconstructed image using only a fraction of the pixels improves over iterations in the GGS method. An example for a sparsity level of 80% on a gray-scale image is illustrated in FIG. 7. In FIG. 7, the orange and blue lines indicate the PSNR and SSIM values of the reconstructed image, respectively. The image quality improves over the iterations initially and saturates soon. The algorithm was terminated based on the relative mean square error (MSE) on the amplitude of the current estimate and the previous estimate within a maximum of 1000 iterations. The termination condition is met when the relative MSE is less than le⁻⁶ for ten consecutive iterations.

Because the Gaussian GS is iterative, the end-to-end computation time depends on the number of iterations required to converge and the time taken for each iteration. As mentioned above, the number of iterations required depends on the relative MSE on the amplitude of the current estimate and the previous estimate. The simulation on 32 images shows that an average of 437 iterations are needed before the termination condition is satisfied, with each iteration running for about 3.5 milliseconds. The total end-to-end time taken for a single channel is 2.26 seconds on average.

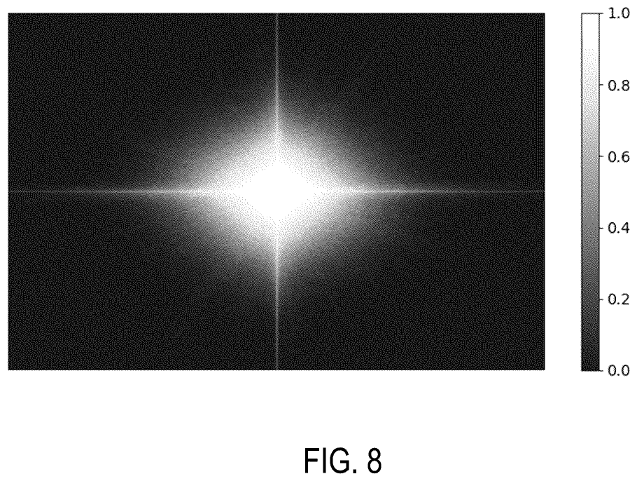

As the Gaussian GS is applied at the image level, the final configuration of the sparse NPA might in theory differ across different images. However, in practice the configurations obtained over different images are, in fact, not very different from each other and have a large intersection of the active pixels. FIG. 8 shows the histogram distribution of the active pixel locations obtained over 32 images, considering only 10% of the total pixels to be active for any image. The sparse NPA is formed by considering the locations of the most frequently occurring pixels. As can be seen from FIG. 8, the most frequently occurring pixels occur in a shape centered at the middle pixel that is an example of a “starburst” shape as the term is used herein. The starburst shape includes pixels in the central rows and central columns of the NPA, in addition to a diamond-shaped or elliptical area centered at the middle pixel. By evaluating the images formed using the top 10% frequent pixels, one can obtain a PSNR of 27.09 and SSIM of 0.87 averaged over 32 images. When 15% of the pixels are used, the PSNR value increases to 28.13 and SSIM to 0.89. This shows that the mean configuration still results in high quality images, but it is not quite as good as the configuration obtained for each image.

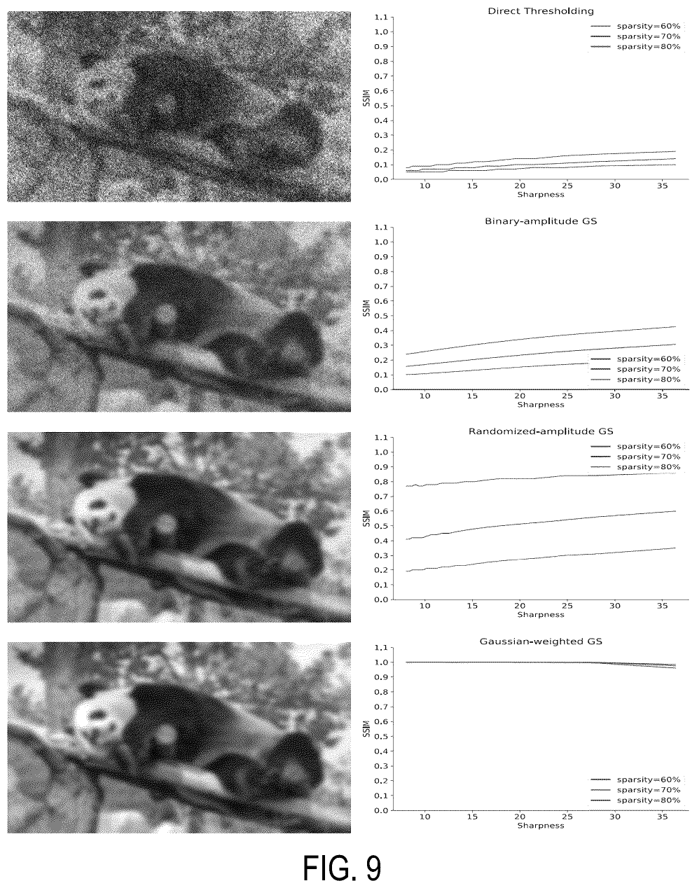

Because the GGS method uses a Gaussian weighted map, one might expect that the achievable sparsity would be affected by the spatial frequency of the image. To test this, a high-resolution image was blurred by convolving it with a Gaussian kernel. The shape of the kernel defines the sharpness of the image and represents the maximum frequency present in the image. The sharpness of an image is represented as the average absolute norm of the gradients present in the image. FIG. 9 shows the effect of various methods on low-pass filtered images. The quality of the images with different sharpness levels is shown on the right column for each method, with reconstruction from a 70% sparse NPA for one smoothed image on the left column. As can be seen from FIG. 9, there is no significant change in the quality of the images formed using Gaussian GS across varying sharpness.

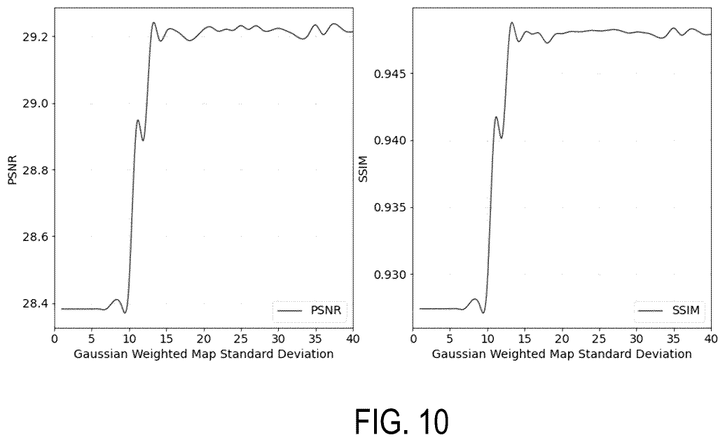

To illustrate the effect of the parameters of the Gaussian weighted map used in the GGS method on the final image quality, FIG. 10 illustrates the SSIM and PSNR of a far-field grayscale image reconstructed from an 80% sparse NPA across various standard deviations of the Gaussian weighted map. In FIG. 10, the reconstructed image quality is plotted relative to the standard deviation of the Gaussian map varied along the longest dimension. The standard deviation along the other dimension is obtained from the aspect ratio. From FIG. 10, it can be seen that the quality increases initially up to a point and then saturates. Further increase in the width of the kernel has no impact on the quality as the method considers only the top few pixels based on their intensity values. Moreover, it is found that the Gaussian sampling method is not limited to the specific type of Gaussian weighted map mentioned above, and can be used more generally with a Gaussian smoothed weighted map centered at any location on the array.

### Sparse NPAs for Holographic Displays— Phase-Only Modulation

As noted above, the GGS method outputs holograms whose amplitude distributions differ across images, which might require a uniquely fabricated chip for each image. However, the present disclosure also contemplates a method which outputs one single configuration which produces a very good approximation of several natural images at the observation plane while maintaining a similar fraction of active elements. The uniform amplitude across the active elements further improves optical power efficiency and reduces the complexity needed for amplitude modulation. This method is referred to herein as a “phase-only” method or a global GGS method.

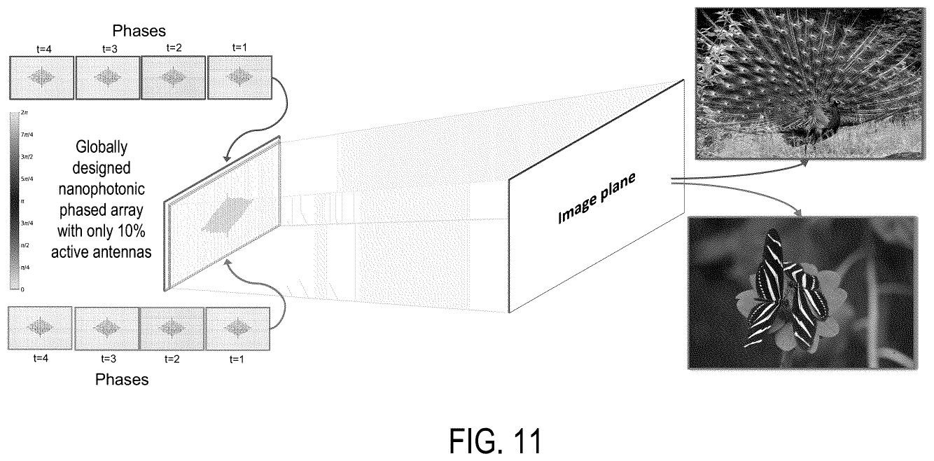

FIG. 11 illustrates a power-efficient NPA with a single configuration consisting of only 10% of active antennas that is globally designed (i.e., effective across a wide range of images). The NPA has the same fixed set of active elements that display multiple natural images, thus enabling practical dynamic holography. The active elements emit light with uniform intensity but varying phases to display different images. This NPA design utilizes time-multiplexing to produce high-quality multiple images at the image plan at high refresh rates.

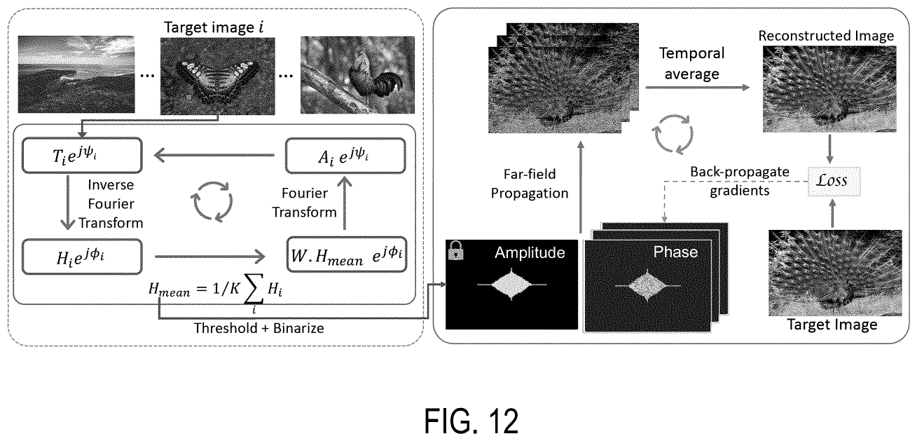

The phase-only framework includes two stages, as shown in FIG. 12 and in the pseudo-code presented below as Algorithm 2. The first stage (blue in FIG. 12) generates the NPA configuration using an iterative approach. The output of the first stage is thresholded to the desired fraction of active elements and binarized to determine the final set of active elements, denoted by the amplitude map in FIG. 12. Once computed, the amplitude map is fixed and maintained the same across all images. The second stage (orange in FIG. 12) takes the fixed amplitude map and computes the time-multiplexed phase holograms corresponding to the set of active elements through an iterative gradient-descent approach. The holograms in the second stage are computed for each image independently.

The input to the phase-only method is the target amplitude patterns Tᵢ ∈ [symbol] ^{P×Q} corresponding to K natural images i ∈[1, 2, . . . , K]. Similar to the GGS method, the phase-only method uses a 2D Gaussian weighted map W∈ [symbol] ^{P×Q} with standard deviations σₓ and σ_{y} along the horizontal and the vertical directions. Each target image is initialized with a random phase ψ⁽⁰⁾ and the corresponding complex amplitude Hᵢ is computed at the source hologram plane. Each iteration is similar to the GGS method, with constraints on the amplitudes at the source and target planes. The amplitude at the source plane is set using the Gaussian weighted mean amplitude of the K holograms Hᵢ₌₁^{k} computed in the previous iteration. The amplitude at the target plane for each image is constrained to its corresponding image amplitude Tᵢ. With these constraints the source amplitudes and phases are iterated until convergence. As above, the function ph(.) in Algorithm 2 represents the phase of a complex amplitude. A fixed number of iterations are performed, and the final mean hologram amplitude Hₘₑₐₙ is output. By maintaining a common source amplitude Hₘₑₐₙ across all images, a single fixed configuration of the NPA that can reconstruct all K images can be ensured. The desired fraction f of active elements may be chosen as those having the highest intensity, which may be considered as the most significant in maintaining the quality of the reconstructed images.

```
Algorithm 2 - Gaussian weighted Gerchberg-Saxton (GGS)
Input: Amplitude Tᵢ (i € [1, K]) at target plane
Output: Amplitude S at source plane
  Initialization:
  W = Gaussian weighted map with widths σₓ and σ_{y}
  $for i = 1 … K do$
  ${ψ}_{i}^{( 0 )} = rand ( ) {H}_{i} = {ℱ}^{- 1} ( {T}_{i} \cdot {e}^{j {ψ}_{i}^{( 0 )}} )$
end for
${H}_{mean} = \frac{{\sum }_{i = 1}^{K} \vert {H}_{i} \vert}{K}$
while iteration < maximum iterations do
  for i = 1 ... K do
    $B = ( \vert {H}_{mean} \vert \cdot W ) {e}^{i ph ( {H}_{i} )} {H}_{i} = {ℱ}^{- 1} \{ {T}_{i} \cdot {e}^{j ph ( ℱ \{ {B}_{i} \} )} \}$
  end for
  ${H}_{mean} = \frac{{\sum }_{i = 1}^{K} \vert {H}_{i} \vert}{K}$
end while
$return S = {H}_{mean}$
```

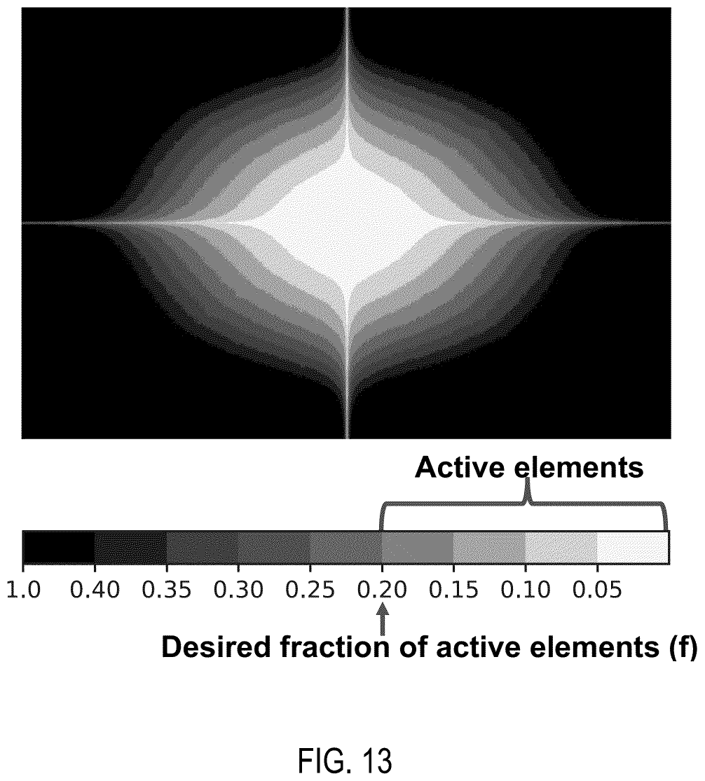

FIG. 13 is a visualization of the global arrangement of the active elements for various desired fractions. It can be observed that the arrangement is a shape that is another example of a “starburst” shape as the term is used herein, with most of the significant elements being concentrated towards the center of the array, mimicking the spectral characteristics of natural images. The global configuration dictates the position of each active element on the NPA. Waveguide routing can be modified to position the elements that emit light with uniform intensity. This may lead to a single fabricated chip with a fixed set of antennas to display multiple high-resolution holographic images in a power-efficient manner.

In the second stage of the global GS pipeline (see FIG. 12), the relative phase shifts at the active elements required to display an image are determined. Different distributions of phases produce different images at the observation plane. This stage follows a gradient-descent-based approach as a technique to produce high-quality results. Let M∈{0,1}^{P×Q} denote the array configuration in which only a small fraction f of the elements are active. A value of 1 in the mask M indicates an active element, while 0 indicates an inactive element. For a target image with an intensity I, the problem of computing the phases ϕ at the source plane with the global configuration may be formulated as minimizing the MSE between the reconstructed amplitude and the target amplitude. Time-multiplexing may further be utilized to improve the quality of the reconstructed images. Holograms with different phases are reconstructed at high speed, thereby averaging out the noise and improving the image quality. As high modulations rates (often on the order of several kHz) are achievable with NPAs, time-multiplexing is a favorable technique to suppress noise in the images. The phase modification objective may be extended to minimize the time-multiplexed phases for the active array configuration, as set forth in the following equation (5).

$$ϕ = arg {min}_{ϕ} {\vert s \sqrt{\frac{1}{N} {\sum }_{n = 1}^{N} \vert ℱ ( M \cdot {e}^{i {ϕ}_{n}} ) \vert} - \sqrt{I} \vert}^{2} \qquad ( 5 )$$

In equation (5), N is the number of temporally averaged frames and s is a scaling factor, using time-multiplexing, an NPA that is fabricated according to this array configuration can easily realize dynamic holographic display with high image quality.

### Simulations— Phase-Only Modulation

The global method was evaluated via simulation to show that a sparse configuration of an NPA displaying multiple different natural holographic images is achieved.

The method was evaluated on the DIV2K dataset, which consists of high-quality, real-life images. The dataset has 800 training and 100 validation images with different resolutions. For the simulation, all images were resized and center cropped to a fixed resolution of 1020×678. All 800 training images were used for the array configuration of in the first stage (see FIG. 12), and the method was validated by reconstructing both training and validation data. The phases at the image plane were initialized form a uniform random distribution, as it aligns more naturally to the light scattered by objects in the real world.

The simulations show the effectiveness of the global GGS method in reconstructing natural images using a single global NPA chip. To validate the method, the global GGS configuration is compared to two baseline methods: GGS as described above, and a fixed random configuration with a uniform amplitude. In the fixed random configuration, a fraction f of elements in the array is randomly chosen and set as active. With this fixed NPA configuration, time-multiplexing and phase-modification are performed corresponding to four frames to reconstruct the image at the target plane.

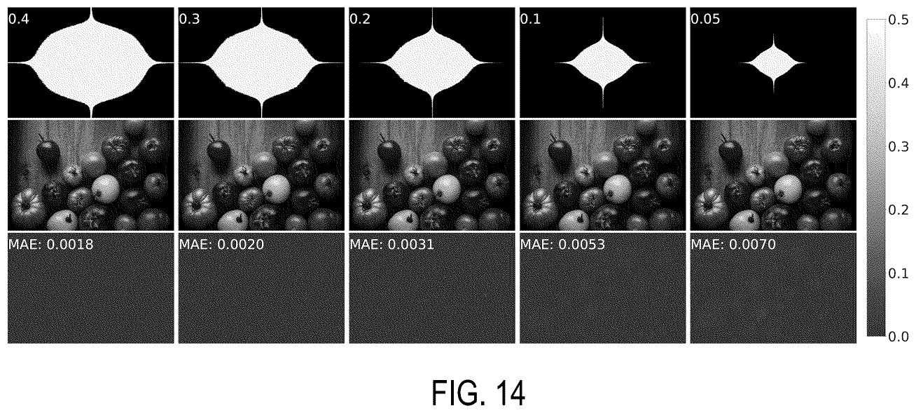

FIG. 14 visually shows the effect of decreasing the fraction of active elements on the quality of the reconstructed image. In FIG. 14, the first row shows the global GGS NPA configuration for fractions of active elements ranging from 0.4 to 0.05. The second and third rows show the reconstructed images and the MAE with the target image for the corresponding fraction. As the fraction of active elements decreases, the elements toward the center of the array and along the vertical and horizontal lines at the center are retained, while the elements much farther away from the center become inactive, as can be seen from the first row. As can be seen from the second and third rows, the highest quality of the image is maintained when at least a 0.2 fraction of the elements are active, and the quality slowly declines with the decrease in the number of active elements. It can further be observed that the regions around the edges of objects in an image suffer in quality as the number of passive (i.e., inactive) elements increases.

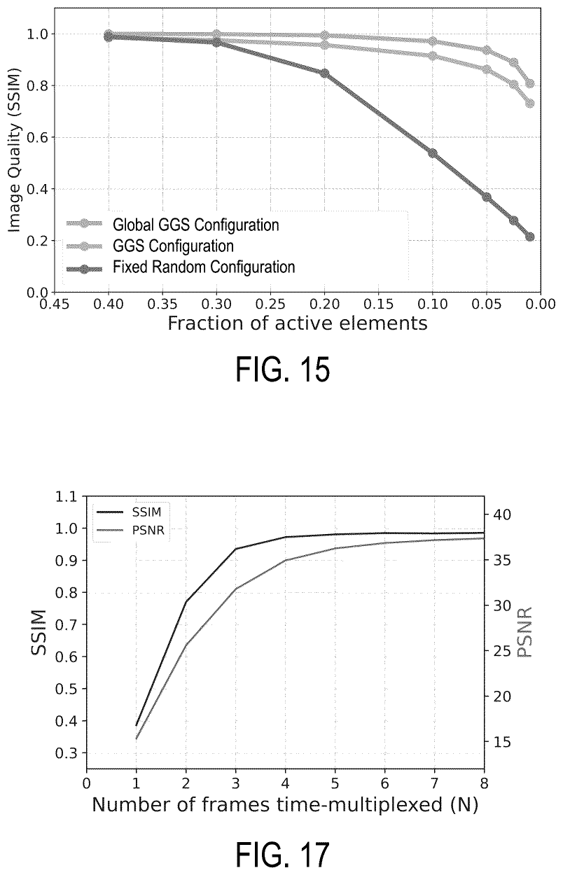

FIG. 15 shows the effect of reducing the fraction of active elements quantitatively. In FIG. 15, the fraction of active elements is decreased gradually from 0.4 to 0.01, and the mean SSIM across the 100 validation images from the DIV2K dataset are plotted. For the GGS configuration, a different set of active elements is used for each image, whereas the global GGS configuration uses the same set of active elements at fixed positions across all images. The quality of the reconstructed images declines slowly as the number of active elements decreases. However, even at an extreme reduction factor of 0.05, it can be seen that the reconstructed images using global GGS have a mean PSNR of 30.47 and SSIM of 0.936 over the 100 validation images.

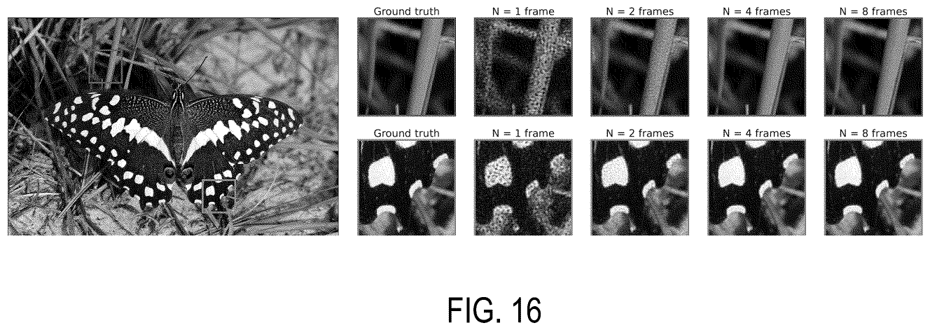

Changes in the number of time-multiplexed frames (N) also affects the image quality. FIG. 16 illustrates reconstructed images by modifying phases over N=1, 2, 4, and 8 time-multiplexed frames using a global GGS configuration with a 0.1 fraction of active elements. From left to right, FIG. 16 shows a target image, zoomed-in views of specific regions corresponding to the target image (“ground truth”), and far-field reconstructions obtained by time-multiplexing N=1, 2, 4, and 8 frames, respectively. From FIG. 16, it can be seen that the images reconstructed without time-multiplexing (N=1) suffer heavily from noise, and that image quality improves as the number of time-multiplexed frames increases. Thus, in FIG. 16, the best quality is obtained when using N=8 frames. This effect is also shown quantitatively in FIG. 17, where the SSIM mean and standard deviation are plotted overall the 800 images from the DIV2K dataset with a varying number of frames N, using a global GGS configuration with a 0.1 fraction of active elements. From FIG. 17, it can be seen that both the PSNR and the SSIM of images improve as the number of frames increases. The improvement, however, saturates when more than four frames are used. Thus, in some examples of implementations of the present disclosure, N=4 is chosen to maintain a good trade-off between image quality and refresh rates, thus achieving high-quality images and high refresh rates.

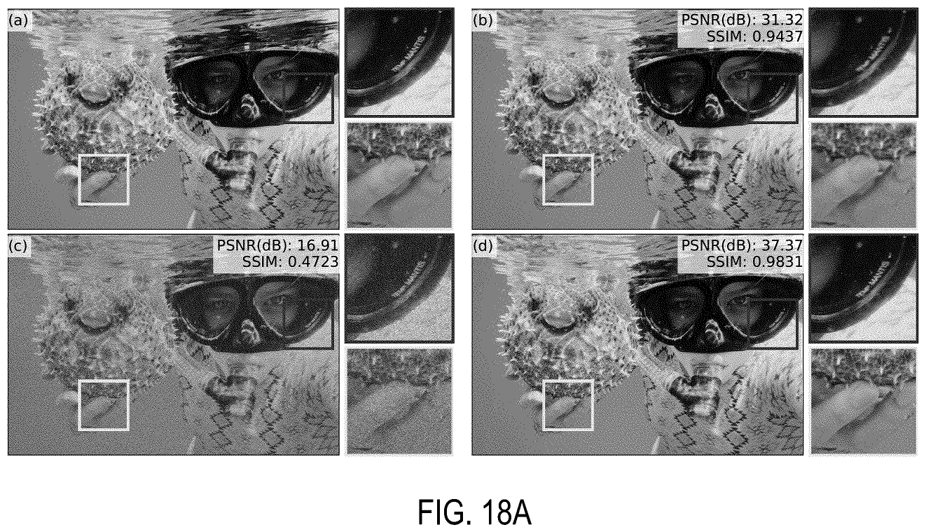

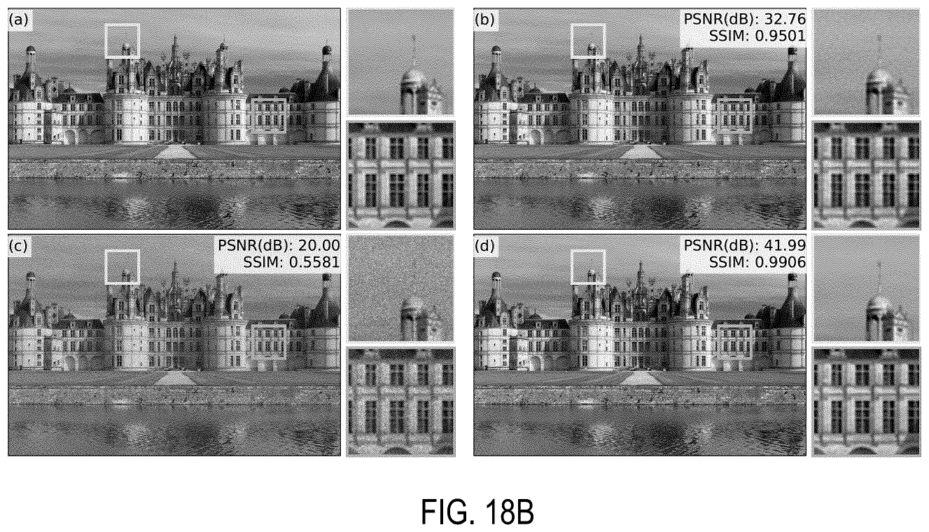

FIGS. 18A and 18B illustrate the simulated reconstructions using the global GGS two-stage pipeline with only a 0.1 fraction (10%) of elements active on the NPA. To analyze the effectiveness of this method, the reconstructions are visually compared with the two baseline approaches mentioned above. In FIGS. 18A and 18B, image (a) shows the target image to be displayed; image (b) shows the reconstructed images using global GS in which the configuration of the NPA differs for each image; image (c) shows the reconstructed images from an NPA with a randomly fixed configuration, in which the amplitude of the active elements is maintained uniformly; and image (d) shows reconstructed images from an NPA with the configuration set to the global GGS configuration. The set of active elements is maintained the same across all images and emit light with uniform intensity. The inserts show the PSNR and SSIM of the reconstructed image. The global GGS method shows a consistent improvement in the image quality over both baselines while maintaining the same (0.1) fraction of active elements. The global GGS produces sharper images than even the GGS method, as shown in the cropped images in FIGS. 18A and 18B. Both the GGS method and the global GGS method show sharper images than the fixed random NPA configuration. Both the global GGS and fixed random configurations use time-multiplexing and average the image intensities over four frames. With the random NPA configuration, the reconstructed holographic images suffer from high-frequency noise. The noise is reduced significantly using the global GGS configuration. This suggests that time-multiplexing alone is insufficient for obtaining high-quality images and that the optimized configuration boosts the quality of reconstructed images obtained using a sparse NPA.

In addition to the qualitative visual comparison of FIGS. 18A and 18B, the configurations are compared quantitatively using PSNR and SSIM in Table 2. Table 2 gives the mean and standard deviation of PSNR and SSIM across all 100 reconstructions from the DIV2K validation dataset from an NPA with a 0.1 fraction of active elements.

TABLE 2

| Method | PSNR | SSIM |
|---|---|---|
| GGS | 29.62 ± 3.61 | 0.91 ± 0.04 |
| Fixed Random | 18.17 ± 2.79 | 0.54 ± 0.12 |
| Global GGS | 34.71 ± 3.89 | 0.97 ± 0.01 |

The first stage of the pipeline (see FIG. 12) runs for 2000 iterations on all 800 images from the DIV2K dataset, and each iterations takes around 9.15 s, leading to a total run-time of five hours. The first stage is executed only once to design an NPA configuration with few active elements. In the second stage, the phases for every color channel of an image are independently modified. The gradient-based optimization is run for 4000 iterations, which takes about 46 s for each channel or a total of 140 s for an image to compute for all three RGB channels.

The above methods may be used to determine a sparse set of active pixels on a 2D phased array, according to a GGS or a global GGS configuration. Thus, the above methods reduce the power consumption for an NPA while maintaining the ability to produce high quality images. In some implementations, the above methods can reduce the number of light-emitting elements by a large amount (e.g., by 90%) while still achieving a perceptually acceptable image. The methods, as set forth above, have been validated using qualitative analyses and quantitative metrics.

The above methods are iterative, with processing time similar to the GS algorithm. In some implementations, the above methods may be modified with massive parallelization using dedicated hardware and machine learning approaches can be leveraged to achieve real-time capability.

While the above description focuses on maintaining the quality of 2D images formed at the far-field plane, the methods can be extended to display 3D volumetric scenes. One way to extend the above approaches to 3D images is to slice the 3D volume into a discrete set of frames at different depths and modulate the NPA for each consecutive frame. The high refresh rates of NPAs make it possible to perceive the 3D scene through time-division multiplexing and fast depth switching.

The above methods output a sparse NPA where the active set of antennas are relatively close to each other in the final configuration. To reduce thermal cross-talk, the above methods may be supplemented with algorithms that allow the active nanoantenna and the corresponding phase shifters to be placed at a larger distance from each other without affecting the quality of the images formed.

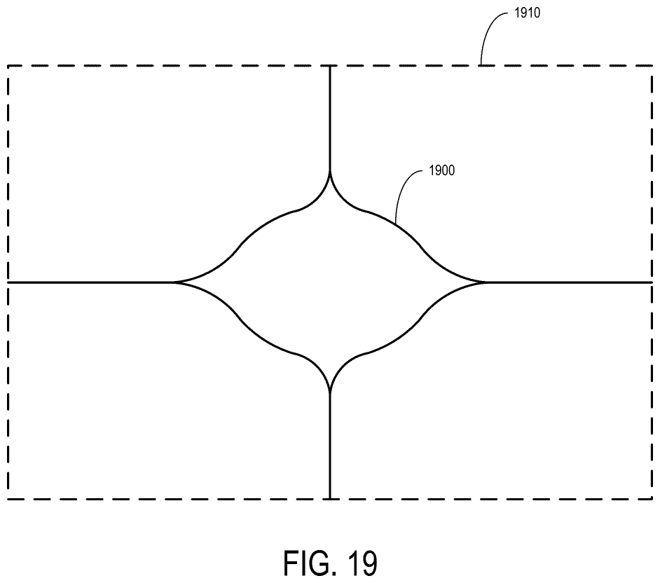

FIG. 19 illustrates an example of a sparse NPA in accordance with the present disclosure. In particular, FIG. 19 illustrates an example of a sparse NPA having a global GGS configuration with a sparsity level of 90% (i.e., a fraction of 0.1 active elements). The sparse NPA includes an active pixel area 1900 where a plurality of light-emitting elements are disposed. The active pixel area 1900 lies within a rectangular footprint 1910, which corresponds to a comparative dense NPA having a resolution of P×Q). Thus, the active pixel area 1900 includes 0.1(P×Q) light-emitting elements in total. The spares NPA design was generated using a Gaussian weight W centered on the center pixel of the rectangular footprint (see equation (4) above), located at (P/2, Q/2). Thus, the active pixel area 1900 is similarly centered on the center pixel (P/2, Q/2). As can be seen from FIG. 19, the active pixel area 1900 has a “starburst” shape and includes a plurality of light-emitting elements arranged in the starburst shape. A total number of the plurality of light-emitting elements in the active pixel area 1900 is equal to the fraction f times a total resolution of a comparative dense NPA with the same rectangular footprint 1910. For example, if the rectangular footprint 1910 corresponds to a dense NPA with a resolution of P×Q, then the active pixel area 1900 includes f (P×Q) pixels.

As used herein, a “starburst” shape is the shape produced by applying either the GGS method or the global GGS method and thresholding the resulting weighted pixel map to a predetermined fraction of active pixels f. In the GGS method, the starburst shape is produced by applying a Gaussian weight to an amplitude map at the target plane to output the amplitude and phase at the source plane for a target image (see Algorithm 1 and the pipeline of FIG. 3). The Gaussian weight may be in the form of a Gaussian-weighted GS algorithm applied in an iterative manner until a convergence condition is satisfied. In the global GGS method, the starburst shape is produced by applying a Gaussian weight to amplitude maps for K images at the target plane, averaging the resultant amplitude maps, and outputting the mean amplitude map corresponding to the source plane amplitude (see Algorithm 2 and the pipeline of FIG. 12). In general, as can be seen from FIG. 19, the starburst shape includes the central row or rows of the rectangular footprint 1910, the central column or columns of the rectangular footprint 1910, and a generally diamond—or ellipse-shaped area centered around the center of the rectangular footprint 1910. Depending on the particular method used (GGS vs. global GGS) and the fraction f of active pixels, the particular details of the starburst shape may vary. However, the starburst shape will generally resemble the shapes illustrated in FIGS. 8 and 13. Of course, the present disclosure is not limited to those threshold values expressly illustrated in FIGS. 8 and 13, and may include any desired fraction f of active pixels.

In some examples, the remainder of the rectangular footprint 1910 outside of the active pixel area 1900 may be free from pixels. In such implementations, the area outside of the active pixel area 1900 and within the rectangular footprint 1910 may be used for one or more pixel circuits associated with the sparse NPA, including but not limited to one or more timing circuits, driving circuits, switching circuits, processing circuits, power circuits, combinations thereof, and the like. By including such circuits within the rectangular footprint 1910 and outside of the active pixel area 1900, the overall footprint of a holographic display using the sparse NPA may be reduced.

In other examples, however, the sparse NPA may be manufactured as a dense array with the entire rectangular footprint 1910 including pixels. In such implementations, the sparse NPA may be controlled such that only the pixels in active pixel area 1900 ever actually emit light. Thus, the remainder of the rectangular footprint 1910 may consist of dummy pixels. Such implementations may be useful to retrofit existing dense NPAs to generate high-quality holographic images with reduced power consumption, and/or may be easier to manufacture in some instances.

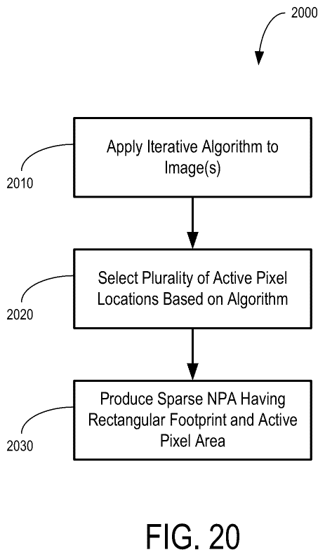

FIG. 20 illustrates one example of a method 2000 of manufacturing a holographic display in accordance with various aspects of the present disclosure. The method 2000 may be used to produce a holographic display including a sparse NPA, such as the sparse NPA illustrated in FIG. 19, by utilizing any of the design methods described above. As illustrated in FIG. 20, the method includes an operation 2010 of applying an iterative algorithm to at least one image, an operation 2020 of selecting a plurality of active pixel locations based on the iterative algorithm, and an operation 2030 of producing a sparse NPA having a rectangular footprint (e.g., the rectangular footprint 1910) including an active pixel area (e.g., the active pixel area 1900) including the plurality of active pixel locations. The active pixel area has a starburst shape as described above. The sparse NPA may then be incorporated into a holographic display (e.g., by providing pixel circuits and/or any other circuitry to drive the NPA).

In one example where the iterative algorithm is configured to produce a GGS configuration, the at least one image may be one image. In this example, the iterative algorithm includes receiving an amplitude map corresponding to the image at a target plane, applying a Gaussian-weighted GS algorithm to the amplitude map in an iterative manner until a convergence condition is satisfied, and outputting an amplitude map and a phase map corresponding to the image at a source plane. Thus, the operation 2010 may include applying Algorithm 1 above. In this example, selecting the plurality of active pixel locations includes selecting a plurality of pixel locations corresponding to the predetermined fraction of pixels of the image at the source plane having a highest amplitude in the amplitude map corresponding to the image at the source plane.

In another example where the iterative algorithm is configured to produce a global GGS configuration, the at least one image may be a plurality of images. In this example, the iterative algorithm includes receiving an amplitude map corresponding to the plurality of images at a target plane; for each of respective image of the plurality of images, applying a Gaussian-weighted GS algorithm to the amplitude map in an iterative manner until a convergence condition is satisfied, and outputting an amplitude map corresponding to the respective image at a source plane; and averaging the amplitude map for each of the plurality of images to generate a mean amplitude map. Thus, the operation 2010 may include applying Algorithm 2 above. In this example, selecting the plurality of active pixel locations includes selecting a plurality of pixel locations corresponding to the predetermined fraction of pixels of the image at the source plane having a highest amplitude in the mean amplitude map.

Examples of the present disclosure can be used in practical applications for perception and energy-efficient holographic displays. Examples of practical applications can include configuration of large-scale sparse NPAs for practical, low-power, and perceptually high-quality holographic displays.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A holographic display, comprising:
a sparse nanophotonic array having a rectangular footprint including an active pixel area,
wherein the active pixel area includes a plurality of light-emitting elements arranged in a starburst shape, and
wherein a total number of the plurality of light-emitting elements in the active pixel area is equal to a predetermined fraction of a total resolution of a dense nanophotonic array having the rectangular footprint.

2. The holographic display according to claim 1, wherein the starburst shape includes a central pixel row of the rectangular footprint, a central pixel column of the rectangular footprint, and a diamond- or ellipse-shaped pixel area centered around a center of the rectangular footprint.

3. The holographic display according to claim 1, wherein the predetermined fraction is 0.1.

4. The holographic display according to claim 1, wherein the starburst shape is determined by:
receiving an amplitude map corresponding to an image at a target plane, the image comprising a plurality of pixels;
applying a Gaussian-weighted Gerchberg-Saxon algorithm to the amplitude map in an iterative manner until a convergence condition is satisfied;
outputting an amplitude map and a phase map corresponding to the image at a source plane; and
selecting a plurality of active pixel locations corresponding to the predetermined fraction of the plurality of pixels of the image at the source plane having a highest amplitude in the amplitude map corresponding to the image at the source plane.

5. The holographic display according to claim 1, wherein the starburst shape is determined by:
receiving an amplitude map corresponding to a plurality of images at a target plane, respective ones of the plurality of images comprising a plurality of pixels;
for each respective image of the plurality of images:
applying a Gaussian-weighted Gerchberg-Saxon algorithm to the amplitude map in an iterative manner until a convergence condition is satisfied, and
outputting an amplitude map corresponding to the respective image at a source plane;
averaging the amplitude map for each of the plurality of images to generate a mean amplitude map; and
selecting a plurality of active pixel locations corresponding to the predetermined fraction of the plurality of pixels of the image at the source plane having a highest amplitude in the mean amplitude map.

6. The holographic display according to claim 5, wherein the starburst shape is further determined by:
applying an iterative gradient-descent approach to compute a plurality of time-multiplexed phase holograms for an image of the plurality of images.

7. The holographic display according to claim 1, further comprising:
a pixel circuit located within the rectangular footprint and outside of the active pixel area.

8. The holographic display according to claim 7, wherein the pixel circuit includes at least one timing circuit, driving circuit, switching circuit, processing circuit, or power circuit.

9. A sparse nanophotonic array having a rectangular footprint, the sparse nanophotonic array comprising:
an active pixel area within the rectangular footprint,
wherein the active pixel area includes a plurality of light-emitting elements arranged in a starburst shape, and
wherein a total number of the plurality of light-emitting elements in the active pixel area is equal to a predetermined fraction of a total resolution of a dense nanophotonic array having the rectangular footprint.

10. The sparse nanophotonic array according to claim 9, wherein the starburst shape includes a central pixel row of the rectangular footprint, a central pixel column of the rectangular footprint, and a diamond- or ellipse-shaped pixel area centered around a center of the rectangular footprint.

11. The sparse nanophotonic array according to claim 9, wherein the predetermined fraction is 0.1.

12. The sparse nanophotonic array according to claim 9, wherein the starburst shape is determined by:
receiving an amplitude map corresponding to an image at a target plane, the image comprising a plurality of pixels;
applying a Gaussian-weighted Gerchberg-Saxon algorithm to the amplitude map in an iterative manner until a convergence condition is satisfied;
outputting an amplitude map and a phase map corresponding to the image at a source plane; and
selecting a plurality of active pixel locations corresponding to the predetermined fraction of the plurality of pixels of the image at the source plane having a highest amplitude in the amplitude map corresponding to the image at the source plane.

13. The sparse nanophotonic array according to claim 9, wherein the starburst shape is determined by:
receiving an amplitude map corresponding to a plurality of images at a target plane, respective ones of the plurality of images comprising a plurality of pixels;
for each respective image of the plurality of images:
applying a Gaussian-weighted Gerchberg-Saxon algorithm to the amplitude map in an iterative manner until a convergence condition is satisfied, and
outputting an amplitude map corresponding to the respective image at a source plane;
averaging the amplitude map for each of the plurality of images to generate a mean amplitude map; and
selecting a plurality of active pixel locations corresponding to the predetermined fraction of the plurality of pixels of the image at the source plane having a highest amplitude in the mean amplitude map.

14. A method of manufacturing a holographic display, comprising:
applying an iterative algorithm to at least one image;
selecting a plurality of active pixel locations based on the iterative algorithm; and
producing a sparse nanophotonic array having a rectangular footprint including an active pixel area including the plurality of active pixel locations.

15. The method of claim 14, wherein the active pixel area has a starburst shape.

16. The method of claim 15, wherein the starburst shape includes a central pixel row of the rectangular footprint, a central pixel column of the rectangular footprint, and a diamond- or ellipse-shaped pixel area centered around a center of the rectangular footprint.

17. The method of claim 14, wherein:
the at least one image is one image, the image comprising a plurality of pixels;
the iterative algorithm includes:
receiving an amplitude map corresponding to the image at a target plane,
applying a Gaussian-weighted Gerchberg-Saxon algorithm to the amplitude map in an iterative manner until a convergence condition is satisfied, and
outputting an amplitude map and a phase map corresponding to the image at a source plane; and
selecting the plurality of active pixel locations includes selecting a plurality of pixel locations corresponding to the predetermined fraction of the plurality of pixels of the image at the source plane having a highest amplitude in the amplitude map corresponding to the image at the source plane.

18. The method of claim 17, wherein the predetermined fraction is 0.1.

19. The method of claim 14, wherein:
the at least one image is a plurality of images, respective ones of the plurality of images comprising a plurality of pixels:
the iterative algorithm includes:
receiving an amplitude map corresponding to the plurality of images at a target plane,
for each respective image of the plurality of images:
applying a Gaussian-weighted Gerchberg-Saxon algorithm to the amplitude map in an iterative manner until a convergence condition is satisfied, and
outputting an amplitude map corresponding to the respective image at a source plane, and
averaging the amplitude map for each of the plurality of images to generate a mean amplitude map; and
selecting the plurality of active pixel locations includes selecting a plurality of pixel locations corresponding to the predetermined fraction of the plurality of pixels of the image at the source plane having a highest amplitude in the mean amplitude map.

20. The method of claim 19, wherein the predetermined fraction is 0.1.
